(19) United States
(12) Patent Application Publication
(10) Pub. No.: US 2020/0308392 A1
(43) Pub. Date: Oct. 1, 2020

(54) COMPOSITION FOR WORM WHEEL HAVING EXCELLENT DURABILITY AND MOISTURE ABSORPTION RESISTANCE AND WORM WHEEL MANUFACTURED USING THE SAME

(71) Applicants: HYUNDAI MOBIS CO., LTD., Seoul (KR); HYOSUNG CHEMICAL CORPORATION, Seoul (KR)

(72) Inventors: Jin Won LEE, Yongin-si (KR); Yeong Ah CHEON, Yongin-si (KR); Woo Jeong OH, Yongin-si (KR); Seong Hwan KIM, Anyang-si (KR); Sung Kyoun YOON, Anyang-si (KR); Joong In KIM, Gunpo-si (KR); Soo Ho SUNG, Seoul (KR); Jae Woo PARK, Seoul (KR)

(21) Appl. No.: 16/831,165

(22) Filed: Mar. 26, 2020

(30) Foreign Application Priority Data
Mar. 26, 2019 (KR) 10-2019-0034316

(51) Int. Cl. C08L 61/02; C08L 77/02

(52) U.S. Cl. CPC C08L 61/02; C08L 2314/08; C08L 77/02

(57) ABSTRACT

The present disclosure relates to a composition for a worm wheel having excellent durability and moisture absorption resistance and a worm wheel manufactured using the same. In one embodiment, the composition for a worm wheel includes about 30 wt % to about 70 wt % of a polyketone copolymer and about 30 wt % to about 70 wt % of a polyamide resin, and the composition for a worm wheel has a friction coefficient of about 0.3 or less as measured in accordance with JIS K7218, an abrasion loss of about 0.002 g or less as measured in accordance with JIS K7218, and a moisture absorption rate of about 4% or less as measured in accordance with ASTM D570 (23° C. and 50 RH %).

### CROSS-REFERENCE TO RELATED APPLICATION

The present application claims priority under 35 U.S.C. § 119(a) to Korean Patent Application No. 10-2019-0034316 filed on Mar. 26, 2019 in the Korean Intellectual Property Office, which is incorporated herein by reference in its entirety.

### BACKGROUND

### 1. Technical Field

Embodiments of the present disclosure relate to a composition for a worm wheel having excellent durability and moisture absorption resistance and a worm wheel manufactured using the same.

### 2. Related Art

A motor-driven power steering (MDPS) is the latest steering performance system using an electric motor, and has been widely applied to small cars and midsize cars. The MDPS drives an electric motor connected directly to a steering system without using hydraulic power, unlike a hydraulic power steering, and has improved fuel efficiency and life span and excellent lightweight characteristics compared to a conventional hydraulic power steering.

The MDPS accurately drives the motor in an electronic control system depending on the vehicle running conditions sensed by various sensors such as a vehicle speed sensor and a steering torque sensor. A torque generated by the motor is transmitted to a steering column or pinion through a reducer, thereby assisting the steering force of a driver operating a steering wheel connected to the steering column and pinion. Accordingly, the motor-driven power steering system provides a light and comfortable steering state during low-speed driving, while providing a heavy and stable steering state during high-speed driving. Furthermore, the motor-driven power steering system may cope with sudden emergency conditions to enable a rapid steering operation, thus providing steering performance to help the driver maintain optimal steering conditions.

Meanwhile, for worm wheels, plastic materials are used for reasons such as NVH issues, lightweightness and cost reduction. In general, as worm wheel materials, polyamide 6 (PA6) and polyamide 66 (PA66) are mainly mass-produced and used, but the polyamide-based polymers have problems in that they have high moisture absorption rates and significant dimensional changes. Polyamide-based worm wheels that are used as precision parts may undergo dimensional changes and stiffness degradation due to environmental influences (moisture contamination). In order to solve this problem, it is necessary to develop a material for a worm wheel having low moisture absorption and high durability properties.

Meanwhile, polyketone (PK) has excellent heat resistance, chemical resistance, impact resistance, wear resistance, dimensional stability and the like, compared to general engineering plastic materials such as polyamide (PA) polyester and polycarbonate (PC), and thus is widely applied in various industries. It is already known that polyketone (PK) having the properties described above is obtained by polymerizing a carbonyl group (CO—) with olefins, such as ethylene and propylene, in the presence of a transition metal complex catalyst such as palladium (Pd) or nickel (Ni), so that the carbonyl group and the olefins are alternately bonded to each other.

Background art related to the present disclosure is disclosed in Korean Patent Application Laid-Open No. 2018-0020501 (published on Feb. 28, 2018; entitled “Polyketone-Carbon Filler Composite and Preparation Method Therefor”).

### SUMMARY

An object of the present disclosure is to provide a composition for a worm wheel having excellent durability, moisture absorption resistance, dimensional stability and reliability.

Another object of the present disclosure is to provide a composition for a worm wheel having excellent lightweightness, wear resistance and mechanical strength properties.

Still another object of the present disclosure is to provide a composition for a worm wheel having excellent productivity, economic efficiency and environmental friendliness.

Yet another object of the present disclosure is to provide a worm wheel manufactured using the composition for a worm wheel.

One aspect of the present disclosure is directed to a composition for a worm wheel. In one embodiment, the composition for a worm wheel includes about 30 wt % to about 70 wt % of a polyketone copolymer and about 30 wt % to about 70 wt % of a polyamide resin, and has a friction coefficient of about 0.3 or less as measured in accordance with JIS K7218, an abrasion loss of about 0.002 g or less as measured in accordance with JIS K7218, and a moisture absorption rate of about 4% or less as measured in accordance with ASTM D570 (23° C. and 50 RH %).

The polyketone copolymer may include repeat units of the following Formulas 1 and 2:

—[—CH₂CH₂—CO—]ₓ— [Formula 1]

—[—CH₂—CH(CH₃)—CO—]_{y}— [Formula 2]

wherein x and y represent the mole percentages of the repeat units of Formulas 1 and 2 in the polyketone copolymer, respectively, and y/x is about 0.03 to about 0.3.

In one embodiment, the polyketone copolymer may have a melting point of about 200° C. or higher and a limiting viscosity number (LVN) of about 2 dl/g to about 3 dl/g as measured in 1,1,1,3,3,3-hexafluoro-2-propanol (HFIP).

In one embodiment, the polyketone copolymer may have a molecular weight distribution of about 1.5 to about 2.5, a melt index of 4 g/10 min or more as measured in accordance with ASTM D1238 at 240° C., and a weight-average molecular weight of about 20,000 g/mol to about 200,000 g/mol.

In one embodiment, the composition for a worm wheel may include about 45 wt % to about 55 wt % of the polyketone copolymer and about 45 wt % to about 55 wt % of the polyamide resin.

In one embodiment, the polyamide resin may include an aliphatic polyamide resin.

In one embodiment, the polyamide resin may have a weight-average molecular weight of about 10,000 g/mol to about 200,000 g/mol.

In one embodiment, the polyamide resin may have a melt index of about 1 g/10 min to about 40 g/10 min as measured in accordance with ASTM D1238 at 250° C.

In one embodiment, the polyamide resin may include one or more of polyamide 6, polyamide 66, polyamide 46, polyamide 610, polyamide 612, polyamide 11, polyamide 12, polyamide 910, polyamide 912, polyamide 913, polyamide 914, polyamide 915, polyamide 616, polyamide 936, polyamide 1010, polyamide 1012, polyamide 1013, polyamide 1014, polyamide 1210, polyamide 1212, polyamide 1213, polyamide 1214, polyamide 614, polyamide 615, polyamide 616, and polyamide 613.

In one embodiment, the composition for a worm wheel may have a tensile strength of about 55 MPa or more as measured in accordance with ASTM D638, an elongation of about 300% or more as measured in accordance with ASTM D638, a flexural modulus of about 1,600 MPa or more as measured in accordance with ASTM D790, and a notched impact strength of about 20 kJ/m² to about 40 kJ/m² as measured on a 4-mm-thick specimen in accordance with ISO 179/1eA at 23° C.

Another aspect of the present disclosure is directed to a worm wheel manufactured using the composition for a worm wheel.

The worm wheel manufactured using the composition for a worm wheel according to the present disclosure may have excellent durability, moisture absorption resistance to external environments such as moisture, and dimensional stability, and thus have excellent reliability. In addition, the worm wheel may have excellent lightweightness, wear resistance, mechanical strength, productivity, economic efficiency and environmental friendliness.

### BRIEF DESCRIPTION OF THE DRAWINGS

FIG. 1 illustrates a worm wheel according to one embodiment of the present disclosure.

FIG. 2 is a perspective view illustrating a worm wheel according to one embodiment of the present disclosure.

FIG. 3 is a graph showing the results of evaluating the durability of worm wheels of Examples according to the present disclosure and Comparative Examples for the present disclosure.

### DETAILED DESCRIPTION

In the following description, the detailed description of related publicly-known technology or configuration will be omitted when it may unnecessarily obscure the subject matter of the present disclosure.

In addition, the terms used in the following description are terms defined taking into consideration the functions obtained in accordance with embodiments of the present disclosure, and may be changed in accordance with the option of a user or operator or a usual practice. Accordingly, the definition of the terms should be made based on the contents throughout the present specification.

Composition for Worm Wheel

One aspect of the present disclosure is directed to a composition for a worm wheel. In one embodiment, the composition for a worm wheel includes about 30 wt % to about 70 wt % of a polyketone copolymer and about 30 wt % to about 70 wt % of a polyamide resin.

Polyketone Copolymer

The polyketone copolymer includes a carbonyl group (CO—) and at least one olefin-based hydrocarbon.

In one embodiment, the olefin-based hydrocarbon may include one or more of ethylene and propylene. For example, the polyketone copolymer may include a linear alternating copolymer of a carbonyl group and ethylene, and a terpolymer of a carbonyl group, ethylene and propylene.

In one embodiment, the polyketone copolymer may include repeat units of the following Formulas 1 and 2:

—[—CH₂CH₂—CO—]ₓ— [Formula 1]

—[—CH₂—CH(CH₃)—CO—]_{y}— [Formula 2]

wherein x and y represent the mole percentages of the repeat units of Formulas 1 and 2 in the polyketone copolymer, respectively, and y/x is about 0.03 to about 0.3.

If y/x of Formulas 1 and 2 above is less than about 0.03, there may be a limitation in that meltability and processability are poor, and if y/x is more than about 0.3, mechanical properties may deteriorate. The polyketone copolymer has a low moisture absorption rate compared to a nylon material, and thus the changes in dimensions and physical properties thereof by moisture absorption may be minimized. In addition, the polyketone copolymer has a lower density than aluminum, and thus may have excellent lightweight properties.

In one embodiment, a method for producing the polyketone copolymer including the repeat units of Formulas 1 and 2 may include the steps of: preparing a catalyst composition including a palladium compound, an acid having a pKa value of about 6 or less, and a phosphorus-based ligand compound; preparing a mixed solvent including alcohol and water; performing polymerization in the mixed solvent in the presence of the catalyst composition; and removing the remaining catalyst composition with a solvent after the polymerization.

As the palladium compound included in the catalyst composition, palladium acetate may be used. As the acid having a pKa value of 6 or less, which is included in the catalyst composition, there may be used one or more selected from the group consisting of trifluoroacetic acid, p-toluenesulfonic acid, sulfuric acid, and sulfonic acid, preferably trifluoroacetic acid. For example, the palladium compound and the acid having a pKa value of about 6 or less may be included at a molar ratio of about 1:1 to about 1:20.

As the phosphorus-based ligand compound included in the catalyst composition, there may be used one or more of 1,3-bis[diphenylphosphino]propane (e.g., 1,3-bis [di(2-methoxyphenylphosphino)]propane, 1,3-bis[bis[anisyl]phosphinomethyl]-1,5-dioxaspiro[5,5]undecane and ((2,2-dimethyl-1,3-dioxane-5,5-diyl)bis(methylene))bis(bis(2-methoxyphenyl)phosphine), and (cyclohexane-1,1-diylbis(methylene))bis(bis(2-methoxyphenyl)phosphine. The phosphorus-based ligand compound may be used in an amount of 1 to 20 moles relative to the palladium compound.

In an embodiment, the mixed solvent may include 100 parts by weight of methanol and about 2 parts by weight to about 10 parts by weight of water. If the content of the water in the mixed solvent is less than about 2 parts by weight based on 100 parts by weight of the methanol, ketal may be formed, which may reduce heat resistance and thermal stability during the process, and if the content of the water is more than about 10 parts by weight, the mechanical properties of the product may deteriorate.

In addition, the polymerization is preferably performed at a reaction temperature of 50° C. to 100° C. and a reaction pressure of 40 to 60 bar. After the polymerization, the produced polymer may be recovered through filtration and purification processes. In addition, the catalyst composition remaining in the polyketone copolymer may be removed with a solvent such as alcohol or acetone.

In one embodiment, the polyketone copolymer may have a melting point of about 200° C. or higher. In one embodiment, the melting point of the polyketone copolymer may be controlled by adjusting the ratio of ethylene to propylene of the polyketone copolymer. In one embodiment, if the molar ratio of ethylene:propylene:carbonyl group is adjusted to 46:4:50, the melting point may be about 220° C. At this melting point, the processability, compatibility and mechanical strength of the composition of the present disclosure may be excellent. For example, the melting point may be about 200° C. to about 250° C.

In one embodiment, the polyketone copolymer may have a limiting viscosity number (LVN) of about 2 dl/g to about 3 dl/g as measured in 1,1,1,3,3,3-hexafluoro-2-propanol (HFIP). Under this condition, the processability and mechanical properties of the composition of the present disclosure may be excellent. For example, the limiting viscosity number may be about 2.0, 2.1, 2.2, 2.3, 2.4, 2.5, 2.6, 2.7, 2.8, 2.9 or 3.0 dl/g.

In one embodiment, the polyketone copolymer may have a molecular weight distribution of about 1.5 to about 2.5. If the molecular weight distribution is less than about 1.5, the polymerization yield may decrease, and if the molecular weight distribution is more than about 2.5, moldability may decrease. For example, the molecular weight distribution may be about 1.5, 1.6, 1.7, 1.8, 1.9, 2.0, 2.1, 2.2, 2.3, 2.4 or 2.5.

In one embodiment, the polyketone copolymer may have a melt index of about 4 g/10 min or more as measured in accordance with ASTM D1238 at 240° C. Under this condition, the processability and mechanical properties of the composition may be excellent. For example, the melt index may be about 4 g/10 min to about 8 g/10 min. For example, the melt index may be about 4, 5, 6, 7 or 8 g/10 min.

In one embodiment, the polyketone copolymer may have a weight-average molecular weight of about 20,000 g/mol to about 200,000 g/mol. Under this molecular condition, the wear resistance, durability and moisture absorption resistance of the composition may be excellent.

In one embodiment, the polyketone copolymer is included in an amount of about 30 wt % to about 70 wt % based on the total weight of the composition for a worm wheel. If the polyketone copolymer is included in an amount of less than about 30 wt %, the moisture absorption resistance, wear resistance and impact strength of the composition may decrease, and if the polyketone copolymer is included in an amount of more than about 70 wt %, the durability, wear resistance and impact resistance of the composition may decrease. For example, the polyketone copolymer may be included in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or 70 wt %.

Polyamide Resin

In one embodiment, the polyamide resin may include an aliphatic polyamide resin.

In one embodiment, the polyamide resin may have a weight-average molecular weight of about 10,000 g/mol to about 200,000 g/mol. In this range, the mechanical strength of the composition of the present disclosure may be excellent.

In one embodiment, the polyamide resin may have a melt index of about 1 g/10 min to about 40 g/10 min as measured in accordance with ASTM D1238 at 250° C. In this range, the miscibility, compatibility and mechanical strength of the composition of the present disclosure may be excellent.

In one embodiment, the polyamide resin may include one or more of polyamide 6, polyamide 66, polyamide 46, polyamide 610, polyamide 612, polyamide 11, polyamide 12, polyamide 910, polyamide 912, polyamide 913, polyamide 914, polyamide 915, polyamide 616, polyamide 936, polyamide 1010, polyamide 1012, polyamide 1013, polyamide 1014, polyamide 1210, polyamide 1212, polyamide 1213, polyamide 1214, polyamide 614, polyamide 615, polyamide 616, and polyamide 613.

In one embodiment, the composition for a worm wheel has a friction coefficient of about 0.3 or less as measured in accordance with JIS K7218, and an abrasion loss of about 0.002 g or less as measured in accordance with JIS K7218. When the composition satisfies these conditions, it may have excellent wear resistance, and thus may be suitable for use as a worm wheel. For example, the friction coefficient may be about 0.05 to about 0.3, and the abrasion loss may be more than about 0 g and not more than about 0.002 g.

In one embodiment, the composition for a worm wheel may have a moisture absorption rate of about 4% or less as measured by ASTM D570 (23° C. and 50 RH %). When the composition satisfies this condition, it may have excellent moisture absorption resistance, and thus may be suitable for use as a worm wheel. For example, the moisture absorption rate may be about 0% to about 3.5%.

In one embodiment, the composition for a worm wheel may have a tensile strength of about 55 MPa or more as measured in accordance with ASTM D638, an elongation of about 300% or more as measured in ASTM D638, and a flexural modulus of about 1,600 MPa or more as measured in accordance with ASTM D790. For example, the composition for a worm wheel may have a tensile strength of about 55 MPa to about 70 MPa as measured in accordance with ASTM D638, an elongation of about 300% to about 420% as measured in ASTM D638, and a flexural modulus of about 1,600 MPa to about 2,500 MPa as measured in accordance with ASTM D790.

In one embodiment, the composition for a worm wheel may have a notched impact strength of about 20 kJ/m² to about 40 kJ/m² as measured on a 4-mm-thick specimen in accordance with ISO 179/1eA at 23° C. Under this condition, the composition may have excellent impact resistance, and thus may be suitable for use as a worm wheel.

In one embodiment, the polyamide resin is included in an amount of about 30 wt % to about 70 wt % based on the total weight of the composition for a worm wheel. If the polyamide resin is included in an amount of less than about 30 wt %, the durability, wear resistance and impact resistance of the composition may be reduced, and if the polyamide resin is included in an amount of more than about 70 wt %, the moisture absorption resistance, wear resistance and impact strength of the composition may be reduced. For example, the polyamide resin may be included in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69 or 70 wt %.

In one embodiment, the composition for a worm wheel may include about 45 wt % to about 55 wt % of the polyketone copolymer and about 45 wt % to about 55 wt % of the polyamide resin.

In one embodiment of the present disclosure, the composition for a worm wheel may be finally prepared by extruding a mixture including the polyketone copolymer and the polyamide resin through an extruder. For example, the composition for a worm wheel may be prepared by introducing a mixture including the polyketone copolymer and the polyamide resin into a twin-screw extruder, and melt-kneading and extruding the mixture. In one embodiment, the extrusion may be performed at an extrusion temperature of about 200° C. to about 260° C. and a screw rotation speed of about 100 rpm to about 300 rpm. Under these conditions, the composition for a worm wheel may be easily prepared.

Worm Wheel Manufactured Using Composition for Worm Wheel

Another aspect of the present disclosure is directed to a worm wheel manufactured using the composition for a worm wheel.

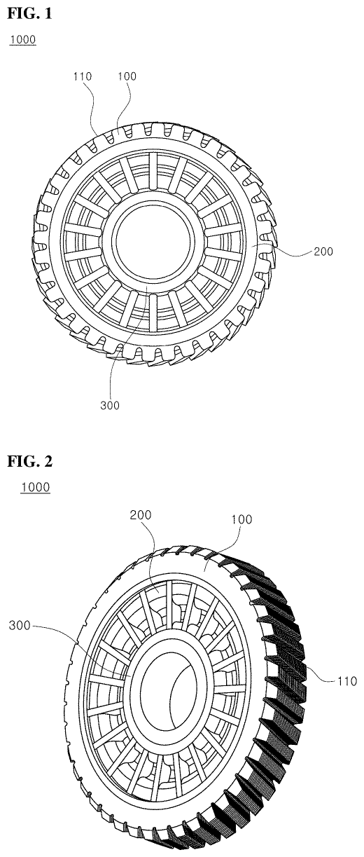

FIG. 1 illustrates a worm wheel according to one embodiment of the present disclosure. FIG. 2 is a perspective view illustrating a worm wheel according to one embodiment of the present disclosure.

Referring to FIGS. 1 and 2, a worm wheel 1000 according to the present disclosure may include: a cylindrical boss portion 300 having a cavity formed in the center thereof; a gear portion 100 having a plurality of gear teeth formed along the outer circumference thereof; and a hub portion 200 formed between the outer circumference of the boss portion 300 and the inner circumference of the gear portion 100, wherein one or more of the boss portion 300, the gear portion 100 and the hub portion 200 may be manufactured using the composition for a worm wheel.

A worm wheel manufactured using a conventional resin composition such as a polyamide resin absorbs moisture in outdoor use environments in which cars run, and hence the mechanical strength of the worm wheel is reduced, resulting in product breakage or dimensional deformation which causes noise and vibration. For this reason, there is difficulty in ensuring the reliability of the worm wheel. However, a worm wheel manufactured using the composition for a worm wheel according to the present disclosure may have excellent durability, moisture absorption resistance to external environments such as moisture, and dimensional stability, and thus have excellent reliability. In addition, the worm wheel may have excellent lightweightness, wear resistance, mechanical strength, productivity, economic efficiency and environmental friendliness.

Hereinafter, the configuration and effects of the present disclosure will be described in more detail with reference to preferred examples. However, these examples are presented as preferred examples of the present disclosure and may not be construed as limiting the scope of the present disclosure in any way.

The contents that are not described herein can be sufficiently and technically envisioned by those skilled in the art, and thus the description thereof will be omitted herein.

### EXAMPLES AND COMPARATIVE EXAMPLES

### Example 1

Production of polyketone copolymer: A catalyst composition including palladium acetate, trifluoroacetic acid and (cyclohexane-1,1-diylbis(methylene))bis(bis(2-methoxyphenyl)phosphine was prepared. At this time, the palladium acetate and the trifluoroacetic acid were included at a molar ratio of 1:10. A carbonyl group, ethylene and propylene were polymerized in a mixed solvent (100 parts by weight of ethanol and 2 to 8 parts by weight of water) in the presence of the catalyst composition. The polymerization was performed in two temperature steps (80° C. in the first step, and 84° C. in the second step), thereby producing a polyketone copolymer including repeat units of the following Formulas 1 and 2:

—[—CH₂CH₂—CO—]ₓ— [Formula 1]

—[—CH₂—CH(CH₃)—CO—]_{y}— [Formula 2]

wherein x and y represent the mole percentages of Formulas 1 and 2 in the polyketone copolymer, respectively, and y/x is 0.03 to 0.3.

In the produced polyketone copolymer, the carbonyl group was 50 mol %, the ethylene was 46 mol %, and the prolylene was 4 mol %. The polyketone copolymer had a melting point of 220° C., a limiting viscosity number of 2.2 dl/g as measured in HFIP (hexafluoroisopropanol) at 25° C., a melt index (MI) of 6 g/10 min as measured in accordance with ASTM D1238 (240° C.), and a molecular weight distribution (MWD) of 2.0.

The polyketone copolymer and polyamide 6 (nylon 6) resin (manufactured by Hyosung Chemical Corp.; melting point: 220° C.; melt index (MI): 20 g/10 min as measured in accordance with ASTM D1238 at 250° C.; weight-average molecular weight (Mw): 25,000; molecular weight distribution (MWD): 1.7) were used in the amounts shown in Table 1 below. The polyketone copolymer and the polyamide resin were introduced into a twin-screw extruder (diameter: 32 mm; and L/D=40) at a screw rotation speed of 250 rpm, melt-kneaded, and extruded, thereby preparing a pellet-shaped composition for a worm wheel. The composition for a worm wheel was injection-molded, thereby manufacturing a worm wheel.

### Examples 2 and 3

Worm wheels were manufactured in the same manner as Example 1, except that the polyketone copolymer and the polyamide 6 resin were used in the amounts shown in Table 1 below.

### Comparative Example 1

A worm wheel was manufactured in the same manner as Example 1, except that only the polyketone copolymer was used without using the polyamide 6 resin.

### Comparative Example 2

A worm wheel was manufactured in the same manner as Example 1, except that only the polyamide 6 resin was used without using the polyketone copolymer.

### Comparative Example 3

A worm wheel was manufactured in the same manner as Example 1, except that only a polyamide 66 resin having a melt index (MI) of 15 g/10 min as measured in accordance with ASTM D1238 at 290° C. was used without using the polyketone copolymer.

### Comparative Examples 4 and 5

Worm wheels were manufactured in the same manner as Example 1, except that the polyketone copolymer and the polyamide 6 resin were used in the amounts shown in Table 1 below.

TABLE 1

| | Examples | | | Comparative Examples | | | | |
|---|---|---|---|---|---|---|---|---|
| Content (wt %) | 1 | 2 | 3 | 1 | 2 | 3 | 4 | 5 |
| Polyketone | 30 to 35 | 50 to 55 | 65 to 70 | 100 | — | — | 25 | 75 |
| copolymer | | | | | | | | |
| Polyamide | 65 to 70 | 45 to 50 | 30 to 35 | — | 100 | — | 75 | 25 |
| 6 resin | | | | | | | | |
| Polyamide | — | — | — | — | — | 100 | — | — |
| 66 resin | | | | | | | | |

Evaluation of Physical Properties

For Examples 1 to 3 and Comparative Examples 1 to 5, physical properties were evaluated under the conditions described below, and the results of the evaluation are shown in Table 2 below.

(1) Tensile strength (MPa) and elongation (%): For Examples 1 to 3 and Comparative Examples 1 to 5, tensile specimens were prepared according to ASTM D638 type 1. Then, the tensile strengths and elongations of the specimens were measured in accordance with ASTM D638 at room temperature.

(2) Flexural modulus (MPa): For Examples 1 to 3 and Comparative Examples 1 to 5, flexural specimens (size: 127 mm (length)×12.7 mm (width)×6.4 mm (thickness)) were prepared in accordance with ASTM D790. Then, the flexural moduli of the specimens were measured in accordance with ASTM D790 at room temperature.

(3) Impact strength (kJ/m²): In accordance with ISO 179/1eA (23° C.), the notched impact strengths of 4-mm-thick specimens of Examples 1 to 3 and Comparative Examples 1 to 5 were measured.

(4) Friction coefficient and abrasion loss (g): In accordance with JIS K7218, the friction coefficients and abrasion losses of specimens of Examples 1 to 3 and Comparative Examples 1 to 5 were evaluated (test conditions: 1 hour of abrasion under conditions of 50 mm/s, 300 N, and counter material S45C).

(5) Moisture absorption rate (%): Moisture absorption rate was measured in accordance with ASTM D570 under conditions of 23° C. and 50 RH %.

TABLE 2

| | Examples | | | Comparative Examples | | | | |
|---|---|---|---|---|---|---|---|---|
| | 1 | 2 | 3 | 1 | 2 | 3 | 4 | 5 |
| Tensile strength (MPa) | 66 | 65 | 62 | 60 | 76 | 84 | 67 | 61 |
| Elongation (%) | 350 | 330 | 400 | 300 | 35 | 21 | 280 | 370 |
| Flexural modulus (MPa) | 2280 | 2120 | 1700 | 1400 | 2800 | 3200 | 2350 | 1650 |
| Impact strength (kJ/m²) | 20 | 24 | 32 | 17 | 5 | 5 | 16 | 28 |
| Friction coefficient | 0.15 | 0.15 | 0.14 | 0.24 | 0.65 | 0.45 | 0.21 | 0.18 |
| Abrasion loss (g) | 0.0006 | 0.0007 | 0.0007 | 0.0025 | 0.0050 | 0.0040 | 0.0017 | 0.0012 |
| Moisture absorption | 3.51 | 2.85 | 2.10 | 1.34 | 5.05 | 3.95 | 3.67 | 1.97 |
| rate (%) | | | | | | | | |

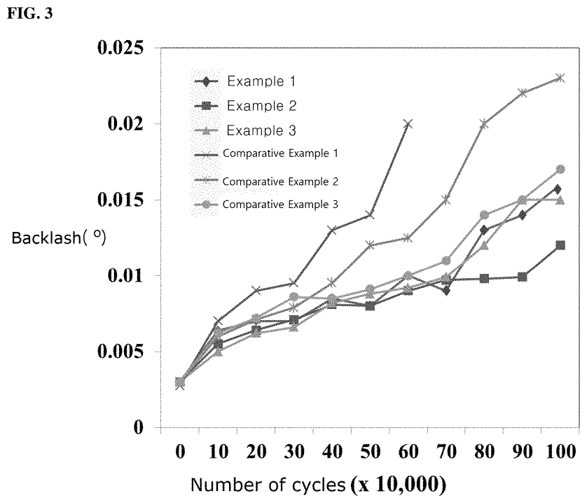

Evaluation of durability: For each of Examples 1 to 3 and Comparative Examples 1 to 3 representative of the Examples and the Comparative Examples, a durability test was performed under the conditions shown in Table 3 below, and the results are shown in Table 4 below and FIG. 3.

TABLE 3

| | 1 cycle | | | |
|---|---|---|---|---|
| | | Rotation | | |
| | Torque | angle | Speed | Durability evaluation |
| Conditions | 85 Nm | ±450° | 180°/sec | Durability: evaluated up to |
| | | | | 1,000,000 cycles; |
| | | | | Backlash: measured every |
| | | | | 100,000 cycles |

TABLE 4

| | Final backlash | Results |
|---|---|---|
| Example 1 | 0.015 | Passed 1,000,000 cycles |
| Example 2 | 0.012 | Passed 1,000,000 cycles |
| Example 3 | 0.015 | Passed 1,000,000 cycles |
| Comparative | Broken | Broken at 500,000 cycles |
| Example 1 | | |
| Comparative | 0.023 | Passed 1,000,000 cycles |
| Example 2 | | |
| Comparative | 0.017 | Passed 1,000,000 cycles |
| Example 3 | | |

FIG. 3 is a graph showing the results of evaluating the durability of the worm wheels of Examples 1 to 3 according to the present disclosure and Comparative Examples 1 to 3 for the present disclosure. Referring to the results in Tables 2 and 4 above and FIG. 3, it can be seen that Examples 1 to 3 according to the present disclosure had excellent mechanical properties, wear resistance, moisture absorption resistance and durability. On the other hand, the worm wheel of Comparative Example 1, manufactured using only the polyketone copolymer without using the polyamide resin, had better water absorption resistance (lower moisture absorption rate) than the worm wheels of Examples 1 to 3, but the impact resistance and wear resistance thereof were lower than those of Examples 1 to 3, and the gear portion of the worm wheel was broken during durability evaluation. It could be seen that, in the case of Comparative Examples 2 and 3 in which the polyketone copolymer of the present disclosure was not applied, the impact resistances, moisture absorption resistances and wear resistances were lower than those of Examples 1 to 3, and the backlash of the gear teeth increased compared to those of Examples 1 to 3 during the durability test. In addition, it could be seen that, in the case of Comparative Examples 4 and 5 in which the contents of the polyketone copolymer and the polyamide resin were out of the ranges according to the present disclosure, the impact resistance or the wear resistance was lower than those of Examples 1 to 3.

Simple modifications or variations of the present disclosure may be easily carried out by those skilled in the art, and all such modifications or variations can be considered included in the scope of the present disclosure.

What is claimed is:

1. A composition for a worm wheel comprising about 30 wt % to about 70 wt % of a polyketone copolymer and about 30 wt % to about 70 wt % of a polyamide resin, the composition having a friction coefficient of about 0.3 or less as measured in accordance with JIS K7218, an abrasion loss of about 0.002 g or less as measured in accordance with JIS K7218, and a moisture absorption rate of about 4% or less as measured in accordance with ASTM D570 (23° C. and 50 RH %).

2. The composition of claim 1, wherein the polyketone copolymer comprises repeat units of the following Formulas 1 and 2:
—[—CH₂CH₂—CO—]ₓ— [Formula 1]
—[—CH₂—CH(CH₃)—CO—]_{y}— [Formula 2]
wherein x and y represent the mole percentages of the repeat units of Formulas 1 and 2 in the polyketone copolymer, respectively, and y/x is about 0.03 to about 0.3.

3. The composition of claim 1, wherein the polyketone copolymer has a melting point of about 200° C. or higher and a limiting viscosity number (LVN) of about 2 dl/g to about 3 dl/g as measured in 1,1,1,3,3,3-hexafluoro-2-propanol (HFIP).

4. The composition of claim 1, wherein the polyketone copolymer has a molecular weight distribution of about 1.5 to about 2.5, a melt index of 4 g/10 min or more as measured in accordance with ASTM D1238 at 240° C., and a weight-average molecular weight of about 20,000 g/mol to about 200,000 g/mol.

5. The composition of claim 1, wherein the composition comprises about 45 wt % to about 55 wt % of the polyketone copolymer and about 45 wt % to about 55 wt % of the polyamide resin.

6. The composition of claim 1, wherein the polyamide resin comprises an aliphatic polyamide resin.

7. The composition of claim 1, wherein the polyamide resin has a weight-average molecular weight of about 10,000 g/mol to about 200,000 g/mol.

8. The composition of claim 1, wherein the polyamide resin has a melt index of about 1 g/10 min to about 40 g/10 min as measured in accordance with ASTM D1238 at 250° C.

9. The composition of claim 1, wherein the polyamide resin comprises one or more of polyamide 6, polyamide 66, polyamide 46, polyamide 610, polyamide 612, polyamide 11, polyamide 12, polyamide 910, polyamide 912, polyamide 913, polyamide 914, polyamide 915, polyamide 616, polyamide 936, polyamide 1010, polyamide 1012, polyamide 1013, polyamide 1014, polyamide 1210, polyamide 1212, polyamide 1213, polyamide 1214, polyamide 614, polyamide 615, polyamide 616, and polyamide 613.

10. The composition of claim 1, wherein the composition has a tensile strength of about 55 MPa or more as measured in accordance with ASTM D638, an elongation of about 300% or more as measured in accordance with ASTM D638, a flexural modulus of about 1,600 MPa or more as measured in accordance with ASTM D790, and a notched impact strength of about 20 kJ/m² to about 40 kJ/m² as measured on a 4-mm-thick specimen in accordance with ISO 179/1eA at 23° C.

11. A worm wheel manufactured using the composition of claim 1.
